(19) United States
(12) Patent Application Publication
(10) Pub. No.: US 2010/0322644 A1
(43) Pub. Date: Dec. 23, 2010

(54) IMAGE FORMING APPARATUS AND METHOD OF DETERMINING AMOUNT OF TONER REMAINING IN TONER CARTRIDGE

(75) Inventor: Hisanobu AJIMA, Kanagawa-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/818,873

(22) Filed: Jun. 18, 2010

Related U.S. Application Data
(60) Provisional application No. 61/218,863, filed on Jun. 19, 2009.

(51) Int. Cl. G03G 15/08

(52) U.S. Cl. 399/27

(57) ABSTRACT

An image forming apparatus includes a remaining amount information acquiring unit, a toner sensing unit, and a determination unit. The remaining amount information acquiring unit acquires remaining amount information on an amount of toner remaining in a cartridge, which is stored in a memory device disposed in the cartridge mounted on an image forming apparatus body. The toner sensing unit senses information on an amount of toner in a developing device performing a developing process using the toner supplied from the cartridge. The determination unit determines that the toner in the cartridge is empty when the remaining amount information acquired by the remaining amount information acquiring unit indicates that the remaining amount is smaller than a predetermined amount of toner and the information on the amount of toner sensed by the toner sensing unit indicates that the amount of toner in the developing device is smaller than a predetermined amount.

### CROSS-REFERENCE TO RELATED APPLICATION(S)

This application is based upon and claims the benefit of priority from: U.S. provisional application 61/218,863, filed on Jun. 19, 2009; the entire contents all of which are incorporated herein by reference.

### FIELD

The present invention relates to a technique of determining an amount of toner remaining in a toner cartridge.

### BACKGROUND

In the past, in an image forming apparatus not including a remaining toner sensor in a toner cartridge, an amount of toner remaining in the toner cartridge was estimated by the use of a sensor disposed in a developing device.

However, the amount of toner remaining in the developing device was actually sensed by the sensor disposed in the developing device, and it was thus difficult to accurately sense the amount of toner remaining in the toner cartridge without disposing the remaining toner sensor or the like in the toner cartridge.

### BRIEF DESCRIPTION OF THE DRAWINGS

FIG. 1 is a longitudinal sectional view of an image forming apparatus according to a first embodiment.

FIG. 2 is a functional block diagram illustrating some functions of the image forming apparatus according to the first embodiment.

FIG. 3 is a data table showing details of information stored in a memory of the image forming apparatus.

FIG. 4 is a data table showing details of information stored in memory devices.

FIG. 5 is a flowchart illustrating a flow of operations until replacement of a toner cartridge is requested after a power source is turned on.

FIG. 6 is a flowchart illustrating a flow of a remaining toner determining process at the time of warming-up.

FIG. 7 is a data table illustrating a toner supply operation which is divided into plural levels.

FIG. 8 is a data table illustrating a toner supply operation which is divided into plural levels.

FIG. 9 is a flowchart illustrating a flow of processes according to a sixth embodiment.

### DETAILED DESCRIPTION

According to an embodiment, an image forming apparatus includes a remaining amount information acquiring unit, a toner sensing unit, and a determination unit.

The remaining amount information acquiring unit acquires remaining amount information on an amount of toner remaining in a cartridge, which is stored in a memory device disposed in the cartridge mounted on an image forming apparatus body.

The toner sensing unit senses information on an amount of toner in a developing device performing a developing process using the toner supplied from the cartridge.

The determination unit determines that the toner in the cartridge is empty when the remaining amount information acquired by the remaining amount information acquiring unit indicates that the remaining amount is smaller than a predetermined amount of toner and the information on the amount of toner sensed by the toner sensing unit indicates that the amount of toner in the developing device is smaller than a predetermined amount.

### First Embodiment

Hereinafter, a first embodiment will be described with reference to the accompanying drawings.

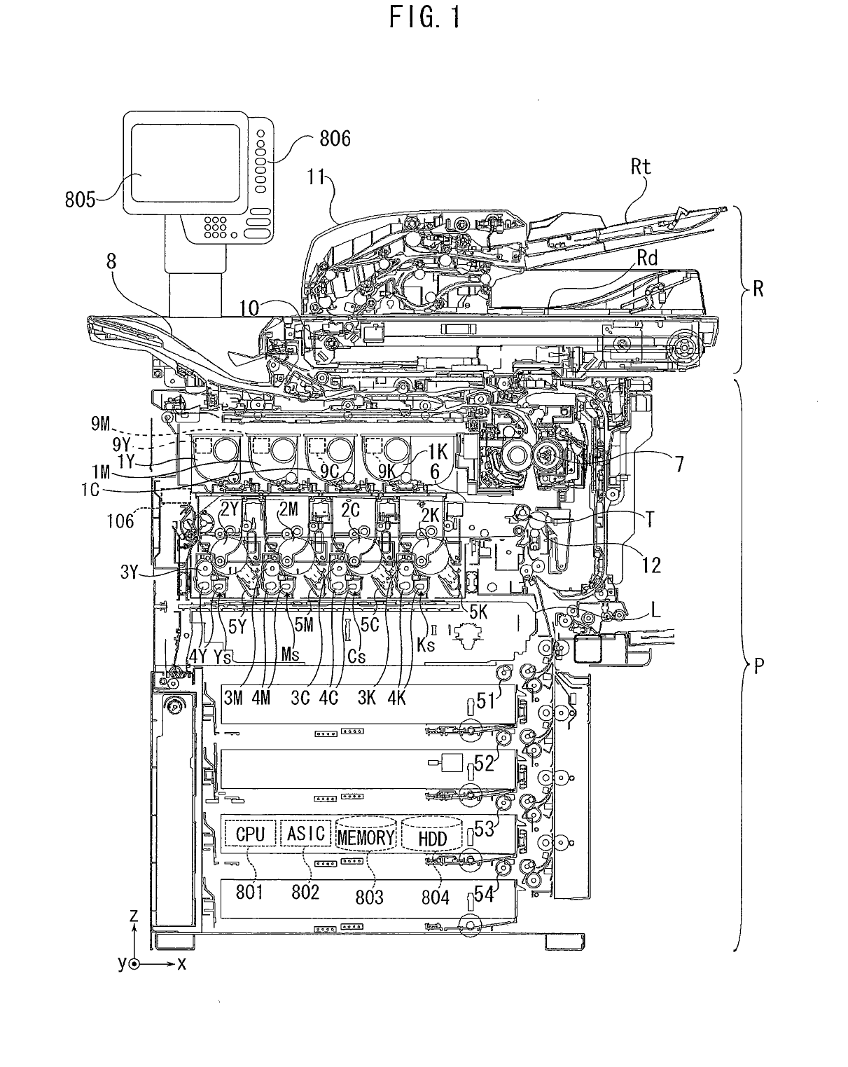

FIG. 1 is a longitudinal sectional view of an image forming apparatus according to the first embodiment.

The image forming apparatus is a multi-function peripheral (MFP) including an image reading section R and an image forming section P.

The image reading section R reads images on documents of sheets and books by scanning.

The image forming section P forms a developer image on a sheet on the basis of an image read from an original document by the image reading section R or image data transmitted to the image forming apparatus from an external device.

The image reading section R includes an automatic document feeder 11. The image reading section R reads an image of a document placed on a document tray Rt automatically fed by the automatic document feeder 11 or a document placed on a document plate Rd.

The image forming section P includes pickup rollers 51 to 54, photoconductive members 2Y to 2K, developing rollers 3Y to 3K, mixers 4Y to 4K, an intermediate transfer belt 6, a secondary transfer roller 12, a fixing device 7, a discharge tray 8, toner cartridges 1Y to 1K, a laser sweep unit L, toner sensing units Ys to Ks, and a toner supply device 106.

The toner cartridges 1Y to 1K can be attached to and detached from an image forming apparatus body. The toner cartridges 1Y to 1K include rewritable memory devices 9Y to 9K such as flash memories, respectively.

The toner sensing units Ys to Ks sense “information on an amount of toner” in a developing device performing a developing process using toner supplied from the toner cartridges 1Y to 1K.

Specifically, the toner sensing units Ys to Ks are an automatic toner control sensor (ATC sensor) estimating at what ratio toner is contained in two-component developer (specific toner concentration) by sensing a variation in magnetic flux density with movement of the two-component developer containing toner and carriers in the developing device.

The toner supply device 106 is a toner storing mechanism, other than the toner cartridges 1Y to 1K, which can individually supply toner to the developing devices corresponding to yellow to black. The toner can be supplied from the toner supply device 106 to the developing devices via a toner supply path having an auger therein.

The image forming apparatus includes a processor 801, an ASIC (Application Specific Integrated Circuit) 802, a memory 803, an HDD (Hard Disk Drive) 804, a display unit 805, and an operation input unit 806. The processor 801 performs various processings in the image forming apparatus. The processor 801 carries out various functions by executing programs stored in the memory 803.

The processor 801 and the ASIC 802 can write information to the memory devices 9Y to 9K and read information from the memory devices 9Y to 9K in the state where the toner cartridges 1Y to 1K are mounted on the image forming apparatus.

The memory 803 may be, for example, a RAM (Random Access Memory), a ROM (Read Only Memory), a DRAM (Dynamic Random Access Memory), an SRAM (Static Random Access Memory), or a VRAM (Video RAM).

The display unit 805 may include, for example, an electronic paper, an LCD (Liquid Crystal Display), an EL (Electronic Luminescence), a PDP (Plasma Display Panel), or a CRT (Cathode Ray Tube).

The operation input unit 806 may include, for example, a keyboard, a mouse, a touch panel, a touch pad, a graphics tablet, or an exclusive button.

The functions of the display unit 805 and the operation input unit 806 may be carried out by the use of a so-called touch panel display.

In the image forming apparatus according to the first embodiment, the processor 801 serves to perform various processes in the image forming apparatus and serves to perform various functions by executing the programs stored in the memory 803, the HDD 804, and the like. The processor 801 can be implemented by a CPU (Central Processing Unit) or an MPU (Micro Processing Unit) which can perform the equivalent computing processes. The HDD 804 can be similarly replaced with a memory device such as a flash memory.

The processor 801 and the ASIC 802 write information and read information to and from the memory devices 9Y to 9K of the toner cartridges 1Y and 1K in a wired or wireless communication manner. The processor 801 and the ASIC 802 can compare the information stored in the memory devices 9Y to 9K with the information stored in the memory 803 or the HDD 804.

An outline of a copying process will be described below as an example of a process in the image forming apparatus.

First, the pickup rollers 51 to 54 feed a sheet from a cassette to a sheet carrying path. Plural roller pairs carry the sheet to a secondary transfer position T.

The image reading section R reads images of plural sheets of documents to acquire image data.

The laser sweep unit L forms electrostatic latent images on photoconductive surfaces of the photoconductive members 2Y, 2M, 2C, and 2K based on the image data.

The mixers 4Y to 4K in the developing devices mix developer in the developing devices. The developing rollers 3Y to 3K supply the developer to the electrostatic latent images on the photoconductive members 2Y to 2K to develop the electrostatic latent images on the photoconductive surfaces of the photoconductive members. The toner cartridges 1Y to 1K supply toner to the developing devices.

The photoconductive members transfer the developer images onto the belt surface of the intermediate transfer belt 6 (so-called primary transfer). The intermediate transfer belt 6 carries the developer image on the rotating belt surface to the secondary transfer position T. The intermediate transfer belt 6 and the secondary transfer roller 12 nip and carry the sheet to the secondary transfer position T and transfer the toner image on the intermediate transfer belt 6 to the sheet.

The fixing device 7 fixes the developer image on the sheet to the sheet by heating.

Plural carrying roller pairs sequentially discharge the sheets, onto which the developer images are heated and fixed, to the discharge tray 8.

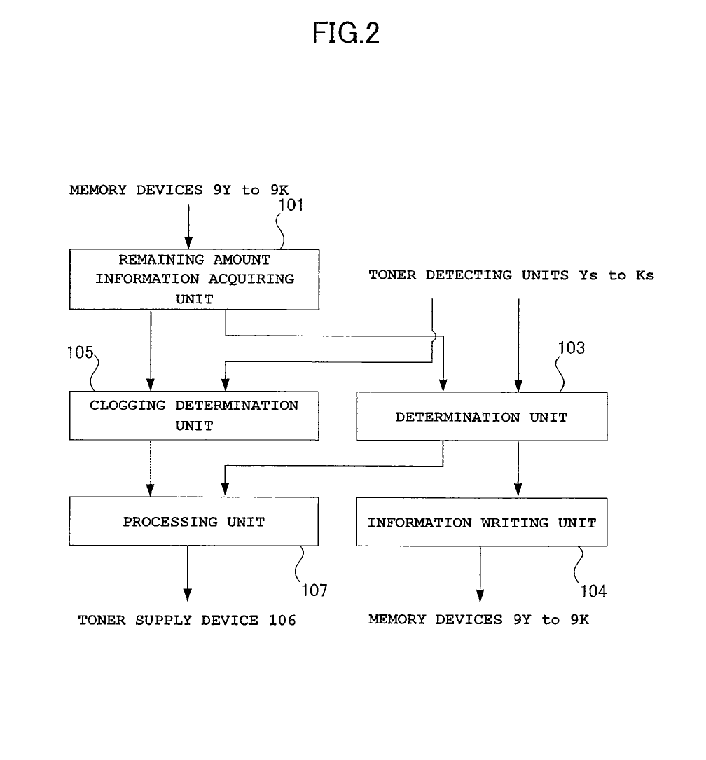

FIG. 2 is a functional block diagram illustrating some functions of the image forming apparatus.

The image forming apparatus includes a remaining amount information acquiring unit 101, a determination unit 103, an information writing unit 104, a clogging determination unit 105, the toner supply device 106, and a processing unit 107.

The remaining amount information acquiring unit 101 acquires “remaining amount information” stored in the memory devices 9Y to 9K of the toner cartridges 1Y to 1K mounted on the image forming apparatus body. Here, the “remaining amount information” is information on an amount of toner remaining in the toner cartridges 1Y to 1K.

Specifically, the remaining amount information acquiring unit 101 acquires the “remaining amount information” when the “information on an amount of toner” sensed by the toner sensing units Ys to Ks indicates that the amount of toner in the developing devices is smaller than a predetermined amount.

The “remaining amount information” is, for example, a counter value counted with the supply of toner from the toner cartridges 1Y to 1K. In this embodiment, the added value of a rotation time of a toner discharging member (auger) discharging the toner in the toner cartridges 1Y to 1K to the outside of the toner cartridges is treated as the counter value. Any value can be used as the counter value, as long as it is information consequently usable for detecting the amount of toner remaining in the toner cartridges 1Y to 1K.

The determination unit 103 determines that the toner in the toner cartridges 1Y to 1K is “empty”, when the “remaining amount information” acquired by the remaining amount information acquiring unit 101 indicates that the amount of toner is smaller than a “predetermined amount of remaining toner” (falls below a near-empty state) and the “information on the amount of toner” sensed by the toner sensing units Ys to Ks indicates that the amount of toner in the developing devices is smaller than a predetermined amount.

Specifically, in the configuration in which the “remaining amount information” is the counter value, the determination unit 103 determines that the toner in the toner cartridges 1Y to 1K is “empty”, when the counter value is greater than a predetermined value and the “information on the amount of toner” sensed by the toner sensing units Ys to Ks indicates that the amount of toner in the developing devices is smaller than a predetermined amount.

The information writing unit 104 writes the “empty information” indicating that the toner in the toner cartridge is “empty” to the memory devices 9Y to 9K of the toner cartridges or the memory 803, when the determination unit 103 determines that one of the toner cartridges 1Y to 1K is “empty”.

When an operation of supplying toner from the toner cartridges is performed in the image forming apparatus, the information writing unit 104 overwrites the counter value stored in the memory devices 9Y to 9K with a value obtained by adding a counted number corresponding to the operation details to the counter value at the time of finishing the operation.

Examples of the “operation of supplying toner from the toner cartridges” include a monochrome printing, a color printing, a copying, and a process of forming an image quality checking pattern in an image quality control. Examples of the “operation details” include the number of printed sheets, a printing rate, the number of rotations of the auger supplying toner from the toner cartridges, and the number of rotations of the auger mixing and supplying toner in the developing devices.

The clogging determination unit 105 determines that the toner supply path from the toner cartridges to the developing devices is clogged with toner, when the “information on the amount of toner” sensed by the toner sensing units Ys to Ks indicates that the amount of toner in the developing devices is smaller than a predetermined amount and the “remaining amount information” indicates that the amount of remaining toner is equal to or greater than a predetermined amount of toner.

The processing unit 107 can notify that the toner in the toner cartridges is “empty”, when the determination unit 103 determines that the toner contained in one of the toner cartridges 1Y to 1K is “empty”.

The processing unit 107 or the processor 801 can cause the display unit 805 or the like to notify that the supply of toner is failed, when the clogging determination unit 105 determines that the supply of toner is failed.

Details of the information stored in the memory devices 9Y to 9K and the memory 803 of the image forming apparatus will be described below.

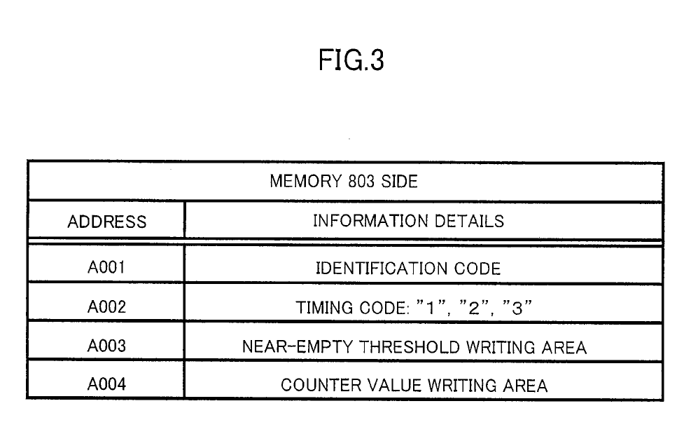

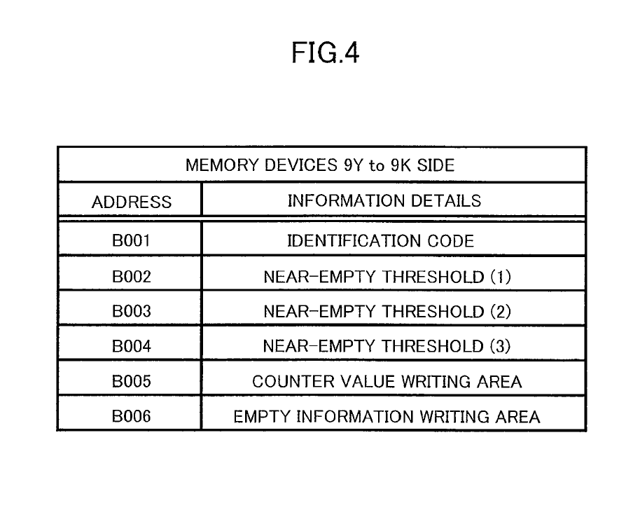

FIG. 3 is a data table showing details of the information stored in the memory 803 of the image forming apparatus. FIG. 4 is a data table showing details of the information stored in the memory devices 9Y to 9K.

The memory 803 disposed in the image forming apparatus body can store four or more types of data. Here, it is assumed that addresses of memory areas disposed in the memory 803 are “A001”, “A002”, “A003”, and “A004”.

The memory devices 9Y to 9K disposed in the toner cartridges 1Y to 1K, respectively, can store six or more types of data. Here, it is assumed that addresses of memory areas disposed in the respective memory devices 9Y to 9K are “B001”, “B002”, “B003”, “B004”, “B005”, and “B006”.

Specifically, an identification code for identifying the corresponding toner cartridge is stored in address “A001”. The processor 801 compares the identification code stored in address “B001” with the identification code stored in address “A001”.

Address “A002” is a memory area for a selection code of a “near-empty threshold” (corresponding to the “predetermined amount of remaining toner”) and stores one of selection codes “1”, “2”, and “3”.

Address “A003” stores a table of near-empty thresholds stored in one of B002, B003, and B004.

Address “A004” stores the counter value.

A process of writing information to the memory 803 and the memory devices 9Y to 9K will be described.

A user selects a threshold for determining the near-empty by the use of a user interface displayed on the display unit 805 by operating the operation input unit 806.

The processor 801 stores the selection code of the near-empty threshold in address “A002” on the basis of the operation input from the operation input unit 806.

The processor 801 acquires table data of the near-empty thresholds stored in one of B002, B003, and B004 and writes the acquired table data to address “A003”, on the basis of the selection code selected as described above.

The processor 801 causes the display unit 805 to display a message of “near-empty” indicating that the amount of toner remaining in the toner cartridges is decreasing when the counter value stored in address “A004” is greater than the threshold stored in address “A003”.

A flow of processes in the image forming apparatus according to the first embodiment will be described.

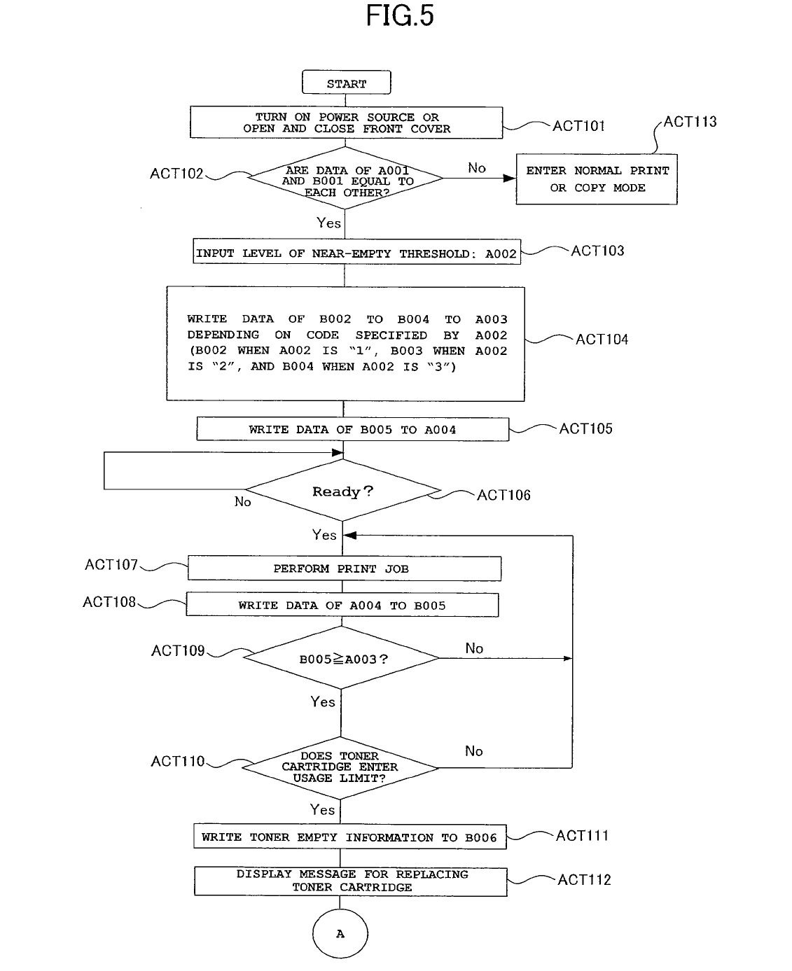

FIG. 5 is a flowchart illustrating operations until the replacement of the toner cartridge is requested after the power source is turned on.

The processor 801 compares data stored in address “A001” of the memory 803 and data stored in address “B001” of the memory devices 9Y to 9K (Act 102) at the time of turning on the power source of the image forming apparatus or opening and closing a front cover (Act 101) which is opened and closed at the time of replacing a toner cartridge.

The processor 801 enters a normal print or copy mode (Act 113) without determining the amount of remaining toner on the basis of the information stored in the memory devices 9Y to 9K, when both data is not equal to each other as the comparison result (NO in Act 102).

On the other hand, when both data is equal to each other as the comparison result (YES in Act 102), the processor 801 writes data of addresses “B002” to “B004” to address “A003” depending on the code input to the address “A002” (Act 103) (data of address “B002” when the code stored in address “A002” is “1”, data of address “B003” when the code is “2”, and data of address “B004” when the code is “3”) (Act 104).

The processor 801 writes the counter data of address “B005” to address “A004” (Act 105) and thereafter, the apparatus body is in a ready state (Act 106).

The processor 801 finishes the operation such as a print job (Act 107) and then writes the counter value of the image forming apparatus body stored in address “A004” to address “B005” of the memory devices 9Y to 9K (Act 108). Examples of this counter value include the number of printed sheets, the number of output pixels, and a counter value usable for estimating the amount of used toner of the toner cartridges. Here, the number of rotations of the auger in the toner cartridges is used as the counter value.

The processor 801 causes the display unit 805 of the image forming apparatus body to display a message of “near-empty” on the screen thereof at the time point when the value of address “B005” becomes greater than the value of address “A003”.

The processor 801 writes the “toner empty information” to address “B006”, when the toner sensing units Ys to Ks sense that the amount of toner in the toner cartridges decreases up to the usage limit (Act 110).

Regarding the writing conditions, it is a necessary condition that the value of address “B005” is equal to or greater than the value of address “A003” (Act 109). When the value of address “B005” is less than the value of address “A003” (NO in Act 109), the “toner empty information” is not written.

The processor 801 displays a message for replacing the toner cartridge on the display unit 805 of the image forming apparatus body at the same time as writing the “toner empty information”. Owing to this writing condition, the erroneous writing can be prevented when a sufficient amount of toner remains but the toner sensing units Ys to Ks determine “empty” due to any failure.

The information on the amount of toner remaining in the toner cartridge is written to the memory device of the toner cartridge. Accordingly, for example, when the toner cartridge is once demounted from the image forming apparatus body and then is mounted again, the information on the amount of remaining toner is treated along with the toner cartridge.

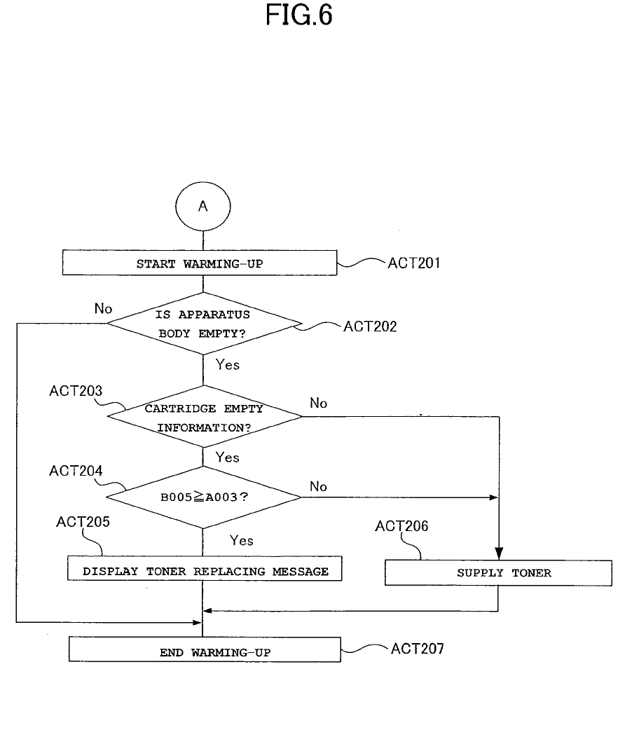

FIG. 6 is a flowchart illustrating a flow of a remaining toner determining process at the time of warming-up.

When the image forming apparatus body is returned from a sleep mode (power save mode) or at the time of warming-up by the turning-on or turning-off of the power source (Act 201), the processor 801 determines the following three conditions (1) to (3) should be satisfied.

(1) Do the toner sensing units Ys to Ks sense the “toner empty”? (Act 202)
(2) Is the empty information as the storage medium information of the toner cartridge written to address “B006” shown in FIG. 4? (Act 203)
(3) Is the value of address “B005” shown in FIG. 4 equal to or greater than the value of address “A003”? (Act 204)

When three conditions (1) to (3) are all satisfied, the processor 801 displays a message for replacing the toner cartridge on the display unit 805 of the image forming apparatus body without supplying toner from the toner cartridge (ACT 205).

When any of the conditions (1) to (3) is not satisfied, the processor 801 causes the toner supply device 106 to supply toner (ACT 206).

The processor 801 completes warming-up operation after finishing above processes (ACT 207).

According to this configuration, it is possible to control a useless toner supply operation after the “toner empty” is determined, thereby reducing a user' standby time. Since any useless toner supply operation is not performed, it is possible to reduce the driving time (traveling distance) of the photoconductive members, thereby contributing to the elongation in the lifetime of the photoconductive members.

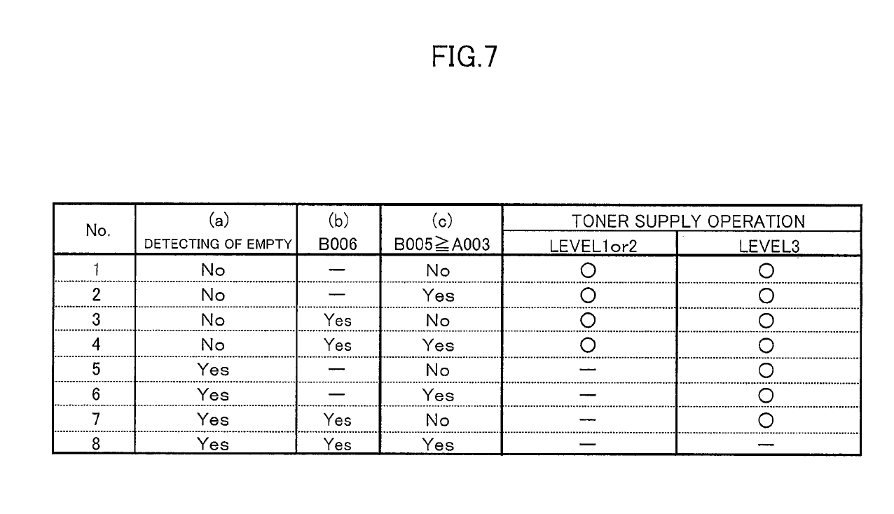

FIG. 7 is a data table illustrating a toner supply operation which is divided into plural levels.

FIG. 7 shows the toner supply operation performed on the basis of the following criteria (a) to (c).

(a) Do the toner sensing units Ys to Ks sense the “toner empty”?
(b) Is the empty information written to address “B006” shown in FIG. 3 as storage medium information of the toner cartridge?
(c) Is the value equal to or greater than the value of address “A003” stored in address “B005” shown in FIG. 3?

The processor 801 sets the criterion (a) to “NO” when the toner sensing units Ys to Ks do not sense the “toner empty”, and sets the criterion (a) to “YES” when the toner sensing units Ys to Ks sense the “toner empty”.

Here, the processor 801 determines the “toner empty” when the toner concentration sensed by the toner sensing units Ys to Ks is lowered by 1.0 wt % or more.

The processor 801 sets the criterion (b) to “-” when the empty information is not stored in address “B006”, and sets the criterion (b) to “YES” when the empty information is stored in address “B006”. The description type of the empty information is not particularly limited, as long as it is identifiable. Here, the processor 801 records “0x03” when the empty information is not stored, and records “0x07” when the empty information is stored.

Regarding the criterion (c), the processor 801 determines whether the value of address “B005” is greater than the near-empty threshold. The processor sets the criterion (c) to “NO” when the value of address “B005” is less than the value of address “A003”, and sets the criterion (c) to “YES” when the value of address “B005” is equal to or greater than the value of address “A003”.

The item as the toner supply operation marked by a circle means that the toner supply operation is performed.

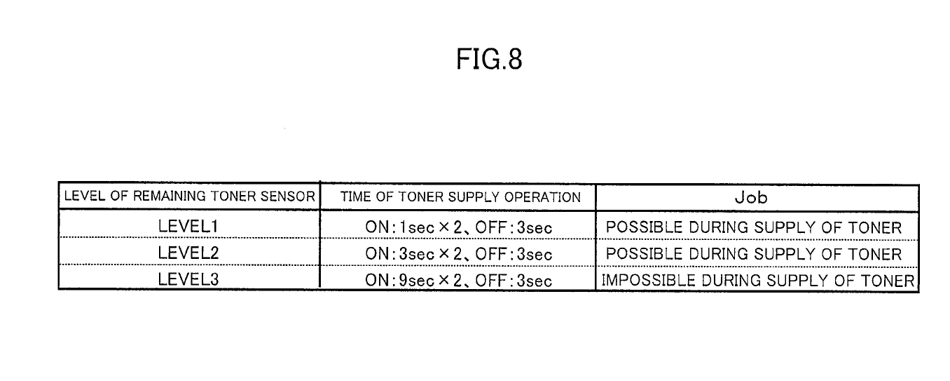

FIG. 8 is a data table illustrating a toner supply operation which is divided into plural levels.

As shown in FIG. 8, the toner supply operation is divided into levels 1 to 3.

“Level 1” is a state where the specific toner concentrations in the developing devices sensed by the toner sensing units Ys to Ks are lowered by 0 wt % to 0.3 wt %. In “level 1”, the processor 801 performs the toner supply operation from the toner cartridges 1Y to 1K during the operation of the apparatus body at ON times of 1 sec×2 and OFF times of 3 sec.

“Level 2” is a state where the specific toner concentrations in the developing devices sensed by the toner sensing units Ys to Ks are lowered by 0.4 wt % to 0.6 wt %. In “level 2”, the processor 801 performs the toner supply operation from the toner cartridges 1Y to 1K during the operation of the apparatus body at ON times of 3 sec×2 and OFF times of 3 sec.

“Level 3” is a state where the specific toner concentrations in the developing devices sensed by the toner sensing units Ys to Ks are lowered by 0.7 wt % or more. In “level 3”, the processor 801 causes the display unit 805 to display a message “Please wait” on the screen at ON times of 9 sec×2 and OFF times of 3 sec while setting the display unit 805 not to accept other operations.

### Second Embodiment

A second embodiment will be described below.

The second embodiment is a modified example of the first embodiment. Hereinafter, elements having the same functions as described in the first embodiment are referenced by the same reference numerals and signs and description thereof is not repeated.

In the second embodiment, the processing unit 107 transmits request information for requesting for a replacement cartridge when the determination unit 103 determines that the toner in the toner cartridges 1Y to 1K is “empty”. Here, the transmission of the request information can be carried out, for example, by the mail transmission to a predetermined E-mail address, the FAX transmission to a predetermined FAX number, the information registration in an external device such as a server via the Internet, or the like.

Specifically, the processing unit 107 in the second embodiment requests for (order) a replacement toner cartridge at the stage where the criterion (a) shown in FIG. 7 is set to “YES” or at the stage where the criterion (c) is set to “YES”.

When the replacement cartridge is ordered at the stage that the criterion (a) shown in FIG. 7 is set to “YES”, it means a state of “toner empty” and thus an inventory control is made, for example, the processing unit 107 orders the replacement cartridge when the quantity of inventory of the cartridges is one.

When the processing unit 107 orders the replacement cartridge, the overlapping of the order can be avoided by using the information of (b) shown in FIG. 7. For example, by making the order in the state of No. 6 in FIG. 2 and not making the order in the state of No. 8, it is possible to avoid the overlapping of the order.

### Third Embodiment

A third embodiment will be described below.

The third embodiment is a modified example of the above-mentioned embodiments. Hereinafter, elements having the same functions as described in the above-mentioned embodiments are referenced by the same reference numerals and signs and description thereof is not repeated.

In the third embodiment, when the determination unit 103 determines that the toner contained in one of the toner cartridges 1Y to 1K is “empty”, the processing unit 107 causes the toner supply device 106 to supply the toner to the empty toner cartridge.

For example, the processing unit 107 can activate the toner supply device 106 in the state of No. 8 in FIG. 7.

When the criterion (b) shown in FIG. 7 is set to “YES” and the criterion (c) is set to “YES”, the supply of toner from the toner supply device 106 may be started.

### Fourth Embodiment

A fourth embodiment will be described below.

The fourth embodiment is a modified example of the above-mentioned embodiments. Hereinafter, elements having the same functions as described in the above-mentioned embodiments are referenced by the same reference numerals and signs and description thereof is not repeated.

In the fourth embodiment, the processing unit 107 changes the control parameters of the image forming process in the image forming apparatus so as to reduce the toner consumption, when the determination unit 103 determines that the toner contained in one of the toner cartridges 1Y to 1K is “empty”.

Here, the “control parameters of the image forming process” can include, for example, a concentration of an image to be printed, a developing bias voltage, a gap of scan beams in a sub scanning direction, and the like.

That is, in the state where it is determined that the toner cartridge is “near-empty” (in the stage that the criterion (c) shown in FIG. 7 is set to YES (the value of address “B005” is equal to or greater than the value of address “A003”)), the processing unit 107 can avoid such a situation that a print job cannot be performed due to the lack of toner, by reducing the toner consumption in the image processing or the process conditions or causing a user to operate the operation input unit 806 to select an operating mode for suppressing the toner consumption so as to print as much images as possible before the replacement with a new toner cartridge.

### Fifth Embodiment

A fifth embodiment will be described below.

The fifth embodiment is a modified example of the above-mentioned embodiments. Hereinafter, elements having the same functions as described in the above-mentioned embodiments are referenced by the same reference numerals and signs and description thereof is not repeated.

In the fifth embodiment, the processing unit 107 can notify that the toner in the toner cartridge is “empty” when the determination unit 103 determines that the toner contained in one of the toner cartridges 1Y to 1K is “empty”. The processing unit 107 may make the notification in the stage (near-empty) that the value of address “B005” is equal to or greater than the value of address “A003” before “empty”.

Specific examples of the notification process by the processing unit 107 can include (1) causing the image forming section P to print details indicating the toner empty on a sheet with a constant period, (2) causing the display unit 805 to display an alarm indicating the toner empty, (3) causing a speaker typically disposed in the image forming apparatus to emit a sound indicating the toner empty, and (4) causing an LED lamp or the like disposed in the image forming apparatus to notify the toner empty by flickering.

### Sixth Embodiment

A sixth embodiment will be described below.

The sixth embodiment is a modified example of the above-mentioned embodiments. Hereinafter, elements having the same functions as described in the above-mentioned embodiments are referenced by the same reference numerals and signs and description thereof is not repeated.

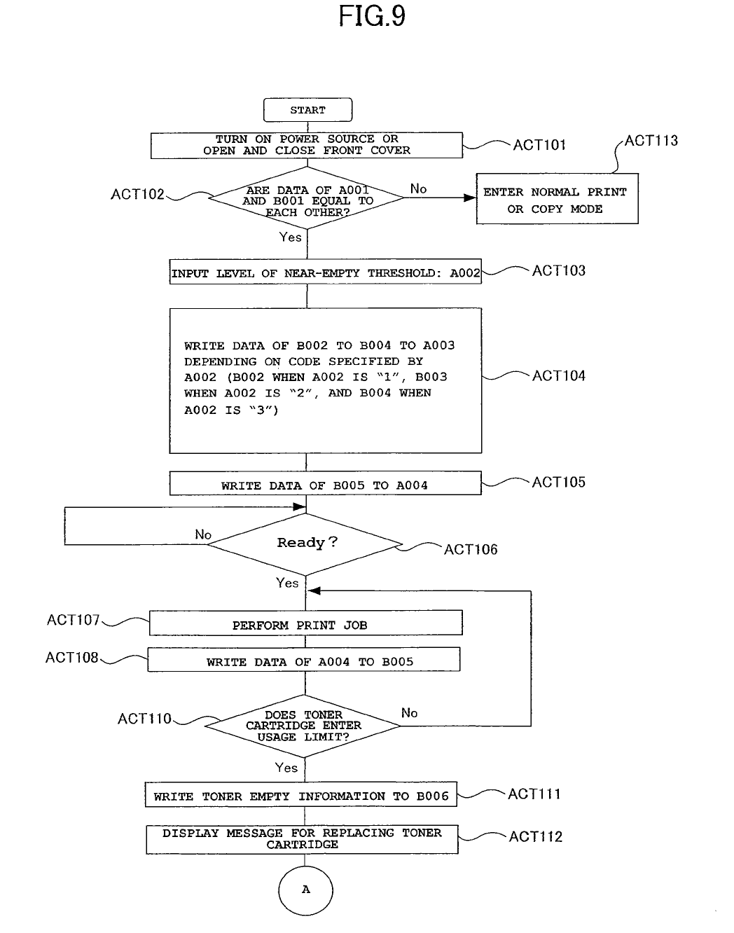

FIG. 9 is a flowchart illustrating a flow of processes according to the sixth embodiment.

In the flow shown in FIG. 9, unlike the flow of processes shown in FIG. 5, the processor 801 does not determine whether the value of address “B005” is equal to or greater than the value of address “A003” to write the toner empty information to address “B006”.

Accordingly, it is possible to reduce the overall process time and to prevent the erroneous determination of the toner empty by determining whether the toner cartridge enters the usage limit (Act 110), even when the toner remains yet, but the “empty information” is written to address “B006” due to any reason.

The operations of the image forming apparatus are implemented by causing the processor 801 to execute the remaining toner determining program stored in the memory 802 or the HDD 804.

A program for causing a computer of the image forming apparatus to perform the above-mentioned various operations can be provided as the remaining toner determining program. Although it is described in the embodiments that the program for implementing the functions is recorded in the memory area in the apparatus in advance, the invention is not limited. The program may be downloaded to the apparatus from a network or the program stored in a computer-readable recording medium may be installed in the apparatus. The type of the recording medium is not particularly limited, as long as it can store the program and can be read by a computer. Specifically, examples of the recording medium include an internal memory device such as a ROM or a RAM built in a computer, a portable recording medium such as a CD-ROM, a flexible disk, a DVD disk, a magneto-optical disk, and an IC card, a database holding a computer program, another computer or a database thereof, and a transmission medium in a communication line. The functions installed in advance or downloaded may be implemented in cooperation with an OS (Operating System) in the apparatus.

All or a part of the program may be an execution module which is dynamically generated.

At least a part of various processes implemented by causing a processor to execute the program in the above-mentioned embodiments can be embodied by circuits in the ASIC 802.

According to the above-mentioned configurations, it is possible to provide a technique of preventing the erroneous determination on the amount of toner remaining in the toner cartridge based on only the sensing of the amount of toner in the developing device.

While certain embodiments have been described, these embodiments have been presented by way of example only, and are not intended to limit the scope of invention. Indeed, the novel apparatus and methods described herein may be embodied in a variety of other forms; furthermore, various omissions, substitutions and changes in the form of the apparatus and methods described herein may be made without departing from the sprit of the inventions. The accompanying claims and their equivalents are intended to cover such forms or modifications as would fall within the scope and spirit of the inventions.

What is claimed is:

1. An image forming apparatus comprising:
a remaining amount information acquiring unit configured to acquire remaining amount information on an amount of toner remaining in a cartridge, which is stored in a memory device disposed in the cartridge mounted on an image forming apparatus body;
a toner sensing unit configured to sense information on an amount of toner in a developing device performing a developing process using the toner supplied from the cartridge; and
a determination unit configured to determine that the toner in the cartridge is empty when the remaining amount information acquired by the remaining amount information acquiring unit indicates that the remaining amount is smaller than a predetermined amount of toner and the information on the amount of toner sensed by the toner sensing unit indicates that the amount of toner in the developing device is smaller than a predetermined amount.

2. The apparatus according to claim 1, wherein the remaining amount information acquiring unit acquires the remaining amount information from the memory device when the information on the amount of toner sensed by the toner sensing unit indicates that the amount of toner in the developing device is smaller than a predetermined amount.

3. The apparatus according to claim 1, wherein the remaining amount information is a counter value counted with a supply of toner from the cartridge, and
wherein the determination unit determines that the toner in the cartridge is empty when the counter value is greater than a predetermined value and the information on the amount of toner sensed by the toner sensing unit indicates that the amount of toner in the developing device is smaller than a predetermined amount.

4. The apparatus according to claim 1, further comprising an information writing unit configured to write empty information indicating that the toner in the cartridge is empty in the memory device disposed in the cartridge, when the determination unit determines that the toner in the cartridge is empty.

5. The apparatus according to claim 4, wherein when an operation of supplying the toner from the cartridge is performed in the image forming apparatus, the information writing unit overwrites a counter value stored in the memory device with a value obtained by adding a counted number corresponding to the operation to the counter value at the time of finishing the operation.

6. The apparatus according to claim 1, further comprising a clogging determination unit configured to determine that a toner supply path from the cartridge to the developing device is clogged with the toner when the information on the amount of toner sensed by the toner sensing unit indicates that the amount of toner in the developing device is smaller than a predetermined amount and the remaining amount information indicates that the remaining amount is equal to or greater than a predetermined amount of remaining toner.

7. The apparatus according to claim 1, further comprising a processing unit configured to transmit information requesting for a replacement cartridge when the determination unit determines that the toner in the cartridge is empty.

8. The apparatus according to claim 1, further comprising:
a toner supply device, other than the cartridge, configured to supply the toner to the developing device; and
a processing unit configured to cause the toner supply device to supply the toner when the determination unit determines that the toner in the cartridge is empty.

9. The apparatus according to claim 1, further comprising a processing unit configured to change a control parameter of an image forming process in the image forming apparatus so as to reduce toner consumption when the determination unit determines that the toner in the cartridge is empty.

10. The apparatus according to claim 1, further comprising a processing unit configured to notify a message that the toner in the cartridge is empty when the determination unit determines that the toner in the cartridge is empty.

11. A method of determining an amount of toner remaining in a toner cartridge, the method comprising:
acquiring remaining amount information on an amount of toner remaining in a cartridge, which is stored in a memory device disposed in the cartridge mounted on an image forming apparatus body;
sensing information on an amount of toner in a developing device performing a developing process using the toner supplied from the cartridge; and
determining that the toner in the cartridge is empty when the acquired remaining amount information indicates that the remaining amount is smaller than a predetermined amount of toner and the sensed information on the amount of toner indicates that the amount of toner in the developing device is smaller than a predetermined amount.

12. The method according to claim 11, wherein the remaining amount information is acquired from the memory device when the sensed information on the amount of toner indicates that the amount of toner in the developing device is smaller than a predetermined amount.

13. The method according to claim 11, wherein the remaining amount information is a counter value counted with a supply of toner from the cartridge, and
wherein it is determined that the toner in the cartridge is empty when the counter value is greater than a predetermined value and the sensed information on the amount of toner indicates that the amount of toner in the developing device is smaller than a predetermined amount.

14. The method according to claim 11, wherein empty information indicating that the toner in the cartridge is empty is written in the memory device disposed in the cartridge, when it is determined that the toner in the cartridge is empty.

15. The method according to claim 14, wherein when an operation of supplying the toner from the cartridge is performed in the image forming apparatus, a counter value stored in the memory device is overwritten with a value obtained by adding a counted number corresponding to the operation to the counter value at the time of finishing the operation.

16. The method according to claim 11, wherein it is determined that a toner supply path from the cartridge to the developing device is clogged with the toner when the sensed information on the amount of toner indicates that the amount of toner in the developing device is smaller than a predetermined amount and the remaining amount information indicates that the remaining amount is equal to or greater than a predetermined amount of remaining toner.

17. The method according to claim 11, wherein information requesting for a replacement cartridge is transmitted when it is determined that the toner in the cartridge is empty.

18. The method according to claim 11, wherein the image forming apparatus body includes a toner supply device, other than the cartridge, supplying the toner to the developing device, and
wherein the toner supply device is caused to supply the toner when it is determined that the toner in the cartridge is empty.

19. The method according to claim 11, wherein a control parameter of an image forming process in the image forming apparatus is changed so as to reduce toner consumption when it is determined that the toner in the cartridge is empty.

20. The method according to claim 11, wherein a message that the toner in the cartridge is empty is notified when it is determined that the toner in the cartridge is empty.
